(19) United States
(12) Patent Application Publication
(10) Pub. No.: US 2005/0141248 A1
(43) Pub. Date: Jun. 30, 2005

(54) Novel efficient and reliable DC/AC converter for fuel cell power conditioning

(76) Inventors: Sudip K. Mazumder, Chicago, IL (US); Rajni K. Burra, Chicago, IL (US); Kaustuva Acharya, Chicago, IL (US)

Correspondence Address: Welsh & Katz, Ltd.;Jon P. Christensen, 22nd Floor, 120 South Riverside Plaza, Chicago, IL, 60606, US

(21) Appl. No.: 10/938,469

(22) Filed: Sep. 10, 2004

Related U.S. Application Data
(60) Provisional application No. 60/501,955, filed on Sep. 11, 2003.

(51) Int. Cl. H02J 1/02

(52) U.S. Cl. 363/39

(57) ABSTRACT

A novel power conditioning converter which provides a significant reduction in input current ripple (<1%), with efficiency above 90% and reduced thermal management is proposed. The converter in discussion has a sort-switched, multilevel, high frequency converter, which acts as an interface between the dc/dc boost and the ac/ac converter. This paper presents a detailed description of the operation of the converter and highlights the important features and advantages. SABER simulation results are presented to provide an improved understanding of the switching mechanisms. A discussion on the implementation of the converter and the status of ongoing work is presented.

This application is a continuation of provisional application No. 60/501,955 filed on Sep. 11, 2003.

### FIELD OF THE INVENTION

Solid oxide fuel cells (SOFC) due to their near-zero emission and high efficiency are becoming and increasingly important source of energy. SOFC typically operate over a temperature range of 600-1000° C. While high temperature is favorable for efficient operation, it is unfavorable from the material reliability point of view. When in operation, the heat generated in the fuel cells is because of (a) entropy heat (T S) generated during the chemical reaction and (b) electrically generated I²R heating.

### BACKGROUND OF THE INVENTION

Power electronic systems (PES) while conditioning the input power, introduce a ripple at the switching frequency. Previous studies and available literature on SOFC, do not establish a direct correlation between the frequency and magnitude of switching ripple on the SOFC temperature and hence their reliability. NETL published guidelines for fuel cell current ripple [1] suggest current ripple less than 60% for frequencies of 10 kHz and above. Meanwhile, power electronics designers (assuming that current ripple has degrading effects on SOFC) are coming up with circuits and techniques to reduce the fuel cell current ripple. Paralleling converters and interleaving of inductors are some of the widely used techniques. Our efforts at UIC are directed towards establishing the bounds for the current ripple and coming up with converter topologies for efficient power conversion and improved reliability. The proposed PES, which is designed for highly efficient power conversion and very low input current ripple, is the first step towards achieving this goal. A detailed description of the circuit operation is presented along with simulated results. Also the main features, specifications and advantages of the converter are described.

### SUMMARY

In this paper a novel dc-ac converter for fuel cell power conditioning is proposed. Main features and advantages of the proposed converter were discussed. Significant reduction in input current ripple (<1%) was achieved, which could eliminate the high frequency thermal cycling of the SOFC.

The high frequency converter is switched on and off under zero-current and the use of the IGBTs results in reduced conduction losses. Therefore the high frequency converter required reduced thermal management.

Arrangement of switches in a multilevel fashion results in reduced voltage stress on devices and hence improves overall converter reliability.

The efficiency figures obtained are above 90% with the peak efficiency of 94.5% for a single phase output and 93.15% for a three phase output.

### BRIEF DESCRIPTION OF THE DRAWINGS

FIG. 1a is a block diagram of the power electronic system under an illustrated embodiment of the invention;

FIG. 1b is a circuit diagram of a specific illustrated embodiment of FIG. 1a;

FIG. 2a is a circuit diagram of a specific illustrated embodiment of the boost converter of FIG. 1a;

FIG. 2b illustrates the transfer function of the boost converter of FIG. 2a;

FIG. 2c1 shows an ideal zero ripple inductor of the boost converter of FIG. 1a with an external inductor and a filter capacitor;

FIG. 2c2 is a transformer model of the boost converter of FIG. 1a showing leakage inductances;

FIG. 2c3 is a transformer model of the boost converter of FIG. 1a showing a transformer model with zero primary leakage inductance;

FIG. 2c4 shows a transformer model of the boost converter of FIG. 1a with an external trimming inductor connected to the secondary;

FIG. 3a is a schematic of the high frequency inverter of the system of FIG. 1a;

FIG. 3b shows gating pulse waveforms with a 50% duty ratio and transformer current of the high frequency inverter of FIG. 3a with two zero current states every switching cycle;

FIG. 4a is a schematic of the AC to AC converter of FIG. 1a;

FIG. 4b is a sine wave modulated PWM control shown for phase a of the schematic of FIG. 4a;

FIG. 4c is a timing chart of the schematic of FIG. 4a showing the sceme for the gating pulses for switches Q1 and Q2;

FIG. 5 shows fuel cell current for the system of FIG. 1a with an extremely low ripple <1% obtained with the zero ripple inductor of FIG. 1a;

FIG. 6 shows the zero current turn-on and turn-off of all four switches of the high frequency inverter of the system of FIG. 1a;

FIG. 7 shows that the current in the AC to AC converter of FIG. 1a is reducted to zero from a positive value when the load current freewheels;

FIG. 8 shows the phase voltages of the AC to AC converter of FIG. 1a at the output of the converter;

FIG. 9a shows the calculated efficiencies of the boost converter of FIG. 1a;

FIG. 9b shows the calculated efficiencies of the multilevel high frequency inverter of FIG. 1a;

FIG. 9c shows the calculated efficiencies of the three-phase DC to AC converter of FIG. 1a; and

FIG. 9d shows the calculated efficiencies of the single phase DC to AC converter of FIG. 1a.

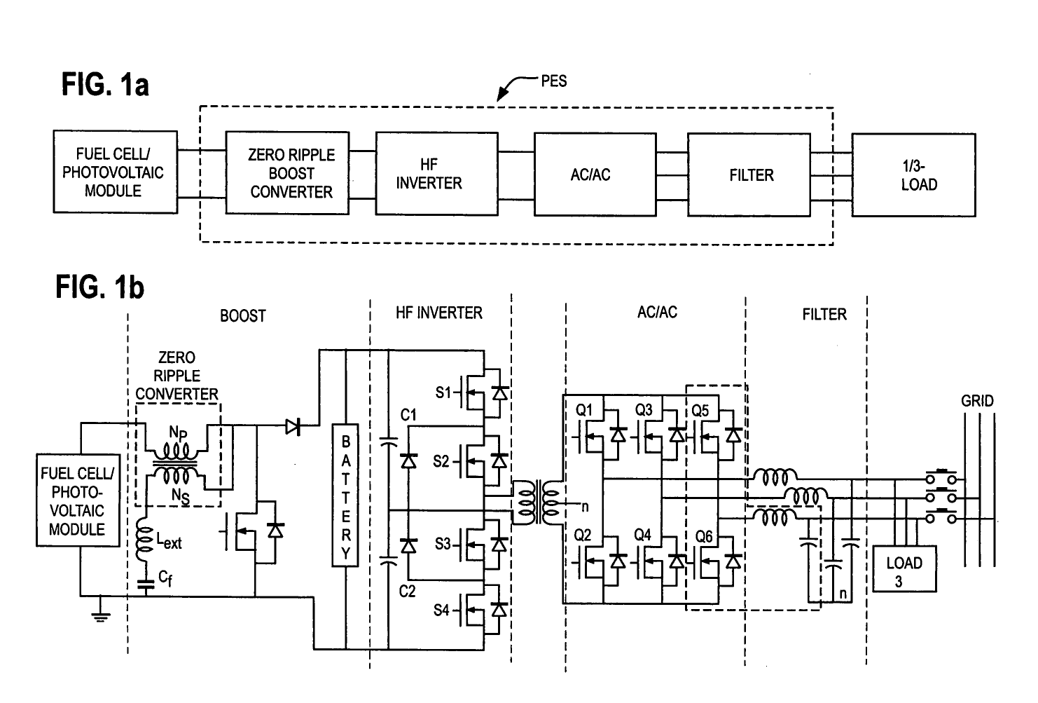

Appendix I is an unpublished article that describes the system of FIGS. 1-9.

### DETAILED DESCRIPTION OF AN ILLUSTRATED EMBODIMENT

The proposed PES (FIG. 1) has the following sub systems: (a) boost converter with a zero ripple inductor (b) soft-switched, high frequency (HF) inverter with a multi-level topology, (c) and an ac/ac converter.

A. Boost Converter

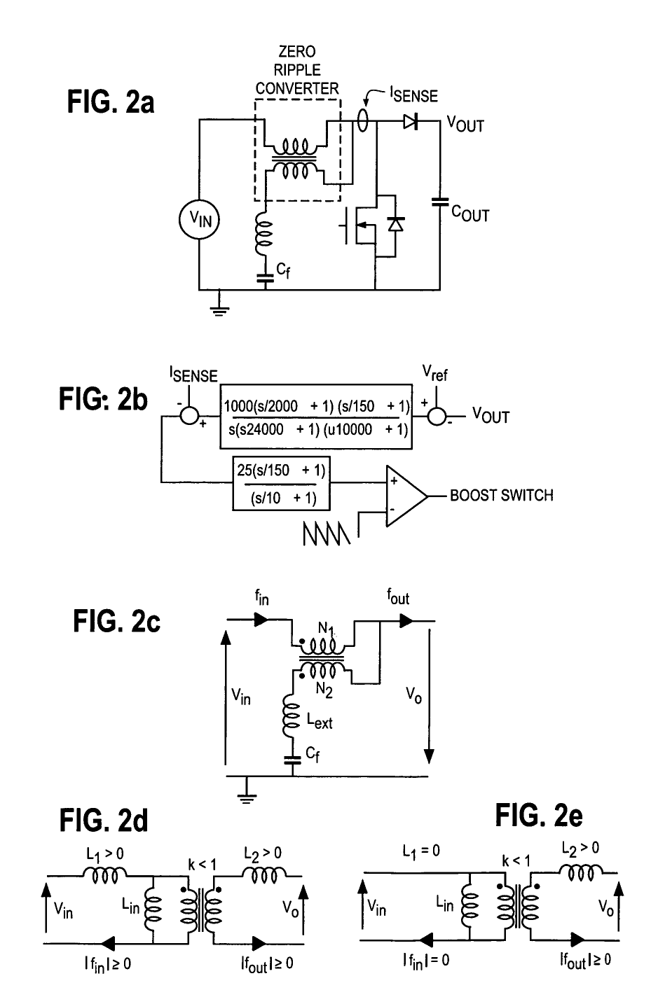

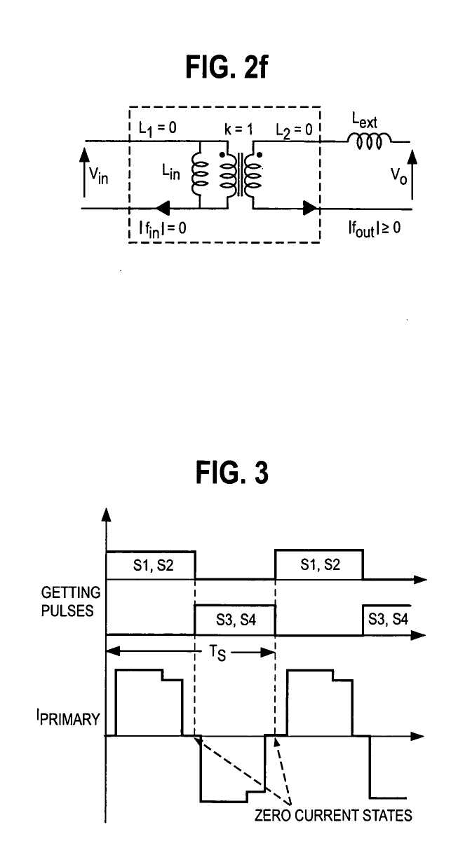

FIG. 2(a) and FIG. 2(b) show the schematic of the boost converter and implemented control respectively. The main feature of the boost converter is the zero-ripple inductor. The zero-ripple inductor shown in FIG. 2(c) has a primary winding and a secondary winding. Secondary winding comprises N₂ turns and has a self-inductance L₂ and the primary winding comprises N₂ turns and has a self-inductance L₂. The windings have a mutual inductance M and a coupling coefficient k given by

$$k = \frac{M}{\sqrt{{L}_{S} {L}_{P}}} \qquad ( 1 )$$

The ripple gain of the inductor is given by

$$\frac{{V}_{in}}{{V}_{o}} = 1 - k \sqrt{\frac{{L}_{P}}{{L}_{S}}} \qquad ( 2 )$$

FIGS. 2(c1-c4) explain the concept of the zero ripple inductor starting with a non-ideal transformer (k<1) (FIG. 2(c2)). The currents Iᵢₙ and Iₒᵤₜ are AC currents and voltages Vᵢₙ and Vₒ are input and output voltages, respectively. In practice k<1 and the secondary winding will have fewer turns than the primary winding. The ripple gain is zero for an ideal zero ripple inductor, but in practice a small ripple will always be there. Ideal zero ripple condition is achieved only when the capacitor C_{f} is infinite. Typically the voltage across the capacitor C_{f} is the same as the input voltage with a small voltage ripple because of ripple current. The secondary winding carries the ripple current and the primary winding carries the dc current. Therefore the primary winding is also called the dc winding [2]. For a tightly coupled inductor (k=1) Lₑₓₜ is adjusted to vary the ripple gain.

B. High Frequency Inverter

The high frequency inverter has 4 switches (S1-S4) arranged in a multilevel fashion [3-6] and a high frequency transformer (N=1) with a center tapped secondary (FIG. 3(a)). Turn-on and turn-off of switches S1, S2 and S3, S4 is complementary without any dead time (FIG. 3(b)). During first half of the switching cycle, S1 and S2 are turned on (S2, S4 are off) allowing the current to ramp up in the primary of the transformer and flow through capacitor C1. Because there is no dead time between the turn off of S1 and S2, and the turn on of S3 and S4, the end of the first half is the beginning of the second half of the cycle. In the second half, current flows through capacitor C2, transformer primary, S3 and S4 and hence the current in is negative. The explanation for the zero-current states will be presented in the following section.

C. AC/AC Converter

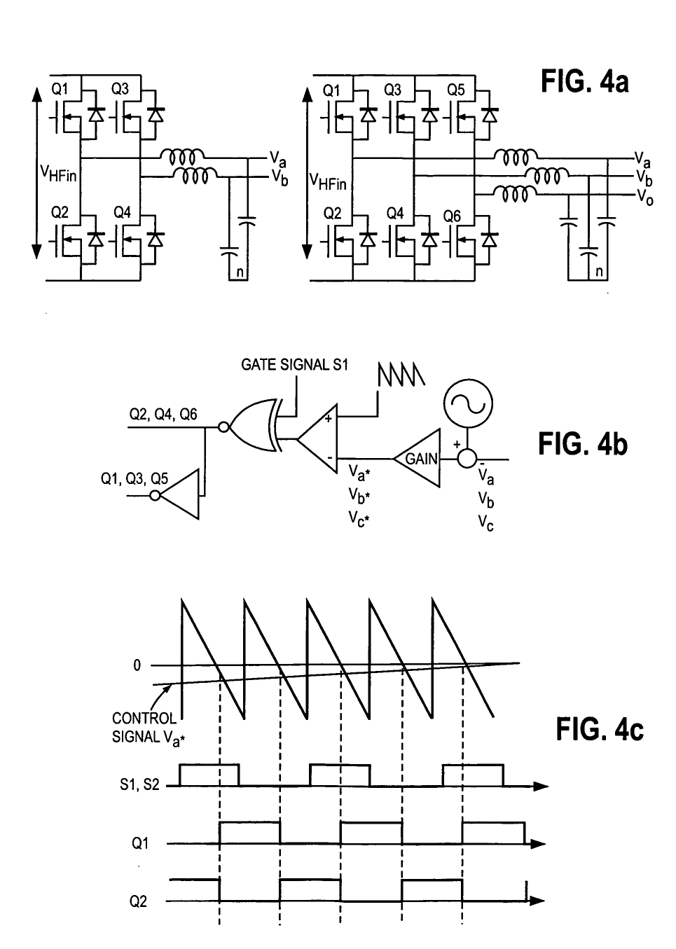

The AC-AC converter has 4 or 6 bidirectional switches (Q1-Q4 or Q1-Q6 for single or three phase output), with two switches on each leg as shown in FIG. 4(a). Switches on each leg are switched complimentary to each other, such that 2 switches on the same leg are never turned on at the same time. A simple sine wave modulated PWM control is implemented to provide gating pulses for the switches. The output voltages Vₐ, V_{b} and V_{c} are compared with sinusoidal references and the resulting control signals Vₐ*, V_{b}* and V_{c}* are fed to the PWM comparator (FIG. 4(b,c)). The obtained PWM signal is EX-NORed with the gate signal of switch S1 of the HF inverter. The high frequency inverter feeds the input of the ac/ac converter.

1) Zero current switching: When the ac/ac converter outputs a non-zero voltage, the load current is supplied from the inverter through the high frequency transformer. When the ac/ac converter output voltage is zero, the load current freewheels in the arms of the ac/ac converter. This results in a zero current n the secondary of the transformer and hence a zero current in the transformer primary. Inverter switches S1, S2 can be turned off and S3, S4 can be turned on simultaneously and vice versa, facilitating zero current switching.

Specifications
Boost Converter:
Input (SOFC stack) voltage: 42 to 70 volts
Output voltage: 350 volts [7]
Input current ripple: <1% @ full load
Frequency: 10 kHz

HF Inverter:
Input voltage: 350 volts
Output voltage: ±175 volts (ac square wave)
Frequency: 10 kHz

AC/AC Converter:
Input voltage: ±175 volts (ac square wave)
Output voltage: ˜120 volts (phase voltage)
Frequency: 10 kHz

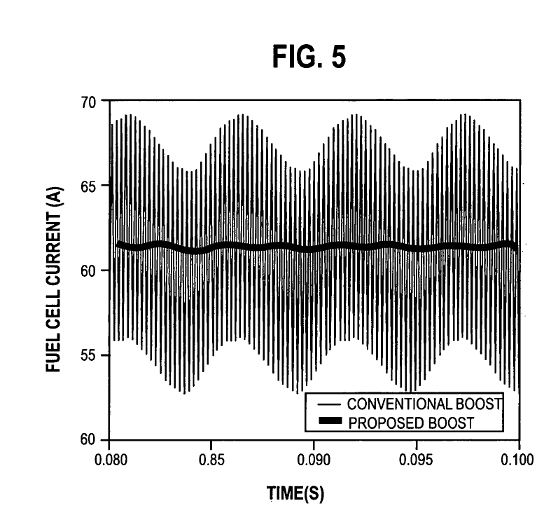

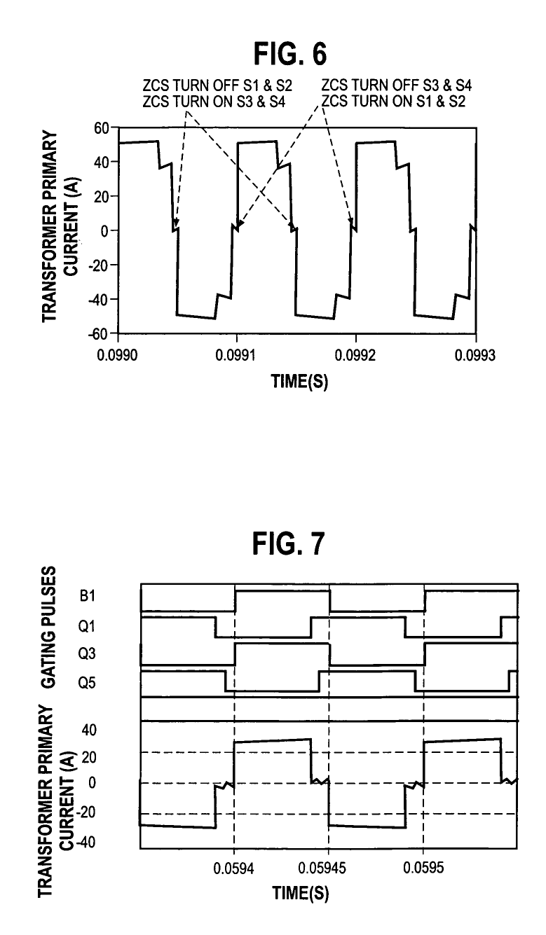

FIG. 5 shows the comparison of the fuel cell current with a zero ripple boost inductor and a conventional inductor. The input ripple current is less than 1% which is at least 15 times lower than what has been reported in literature. Very recently ripple current of 5% have been reported which is still higher as compared to our data. The transformer primary current in FIG. 6 shows that the high frequency converter is a practically lossless converter. All the four switches turn on and off when the current is zero and if IGBT's are used the conduction losses could be significantly reduced. The lossless operation of the high frequency inverter, directly translates to reduced thermal management; thereby reducing the bulk and weight and increasing power density.

As discussed before, zero current states in the transformer primary are caused by the load current freewheeling in the arms of the ac/ac converter. FIG. 7 shows that, when the primary current is positive and all the upper three switches Q1, Q3 and Q5 are turned on simultaneously the primary current jumps to zero instantaneously. This is because the load current freewheels through the load and the upper 3 switches of the ac/ac converter. Similarly, when the primary current is negative and the lower switches Q2, Q4 and Q5 are turned on, the current approaches zero from the negative side and created another zero current state.

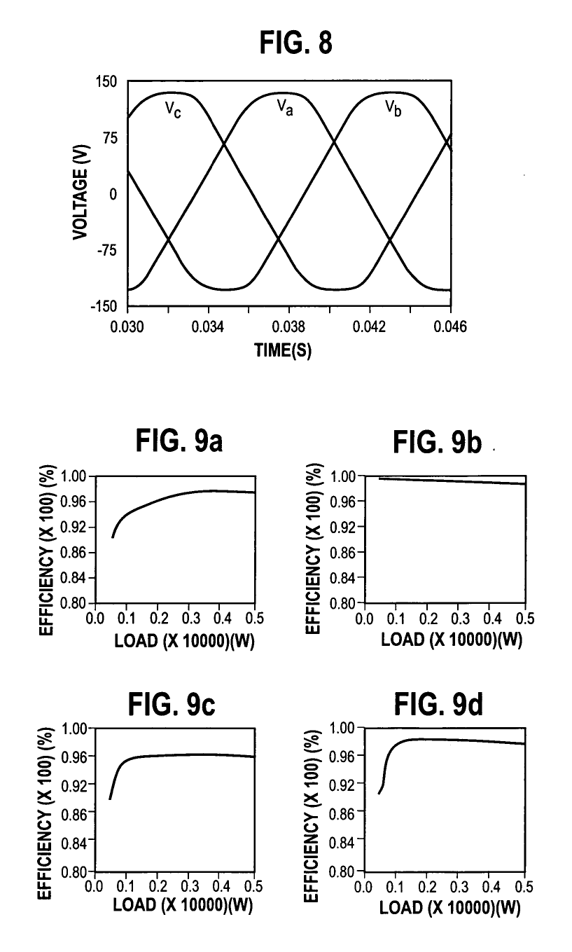

FIG. 8 shows the output voltage for the three phases at full load. The obtained output voltage waveforms are almost sinusoidal and the small amount of distortion is because of low filter values that were used.

FIG. 9 shows the predicted efficiency to be greater than 90% at full load and the peak efficiency is 94.5% for a single phase output and 93.15% for a three phase output. While carrying out SABER simulations all the parasitics (capacitor ESRs and internal resistance of the inductor etc) were taken into account. Therefore the estimated efficiency is a true reflection of the actual system performance.

During our initial analysis the possibility of a ZVZCS converter was also investigated. Since sufficient current is not available in the primary of the transformer (because of the zero current states) to discharge the output capacitance of the MOSFET body diode or the external diode of the IGBT, zero voltage turn is not a possibility. Again, the switches used for high frequency converter has a ZCS turn off the use of IGBTs is preferred which would also result in reduced conduction losses.

TABLE I
Efficiency comparisons of the proposed PES (and its subsystems) with the
state-of-the-art fuel-cell and photovoltaic power electronics based on data in published
literature. Unless specified otherwise, the efficiencies are measured at 5 kW.

| | No. of Output | PES and its subsystems | | | |
|---|---|---|---|---|---|
| System | Phases | DC—DC Bo oat | Multilevel DC—DC | DC-AC | Overall PES |
| 1 [8] | NA | 96% (PC | Not Applicable | NA | NA |
| 2 [8] | NA | 94% (PC) | Not Applicable | NA | NA |
| 3 [9] | NA | NA | 92% @ 1.5 kW | NA | NA |
| | | | (measured) | | |
| 4 [10] | 1 | 92% @1 kW | NA | 87% @1 kW | 80% @1 kW |
| | | (measured) | | (measured) | (measured) |
| 5 [11] | 1 | NP | NA | NP | 92% (measured) |
| 6 [12] | 1 | NP | NA | NP | 90% (measured) |
| 7 [13] | 1 | NP | NA | NP | 92% (measured) |
| 9 [4] | 3 | NP | NA | NP | 89% @ 1 kW |
| | | | | | (measured) |
| 10 [7] | 3 | NP | NA | NP | 90% |
| Proposed | 1 | 98% (PC) | 98.5% (PC) | 98% (PC) | 94.5 (PC) |
| PES | 3 | 98% (PC) | 98.5% (PC) | 98% (PC) | 93.15% (PC) |

NA—Not Applicable
NP—Not Published
PC—Preliminary Calculation

Table IV indicates that, while the efficiency of the boost stage is comparable to that of the other boost topologies proposed in the literature, a significant improvement in the efficiencies of the dc-ac stage has been achieved. The dc-ac converter discussed in [4] uses inefficient switching mechanism as shown in FIG. 3, [4]. Conduction losses would be significantly higher in these switches than the conventional power MOSFET used in the proposed topology. The multilevel converter in [9] operates at a switching frequency of 100 kHz, hence its switching losses are much higher than the proposed converter (which operates at 10 kHz); hence a significant improvement in efficiency is obtained.

The actual prototype with 2 dc-dc converter modules in parallel gives 98% efficiency (Table IV), with each component rated for “half” the output power and all the magnetics for the 2 modules “integrated” on the same core. The cost of fabrication of the PES meets $40/kW. The proposed PES can be easily extended to applications with power rating higher than 10 kW by paralleling the power modules.

1. A power electronic system for conditioning power from a fuel cell, such system comprising:
a boost converter adapted to boost a voltage of a direct current output voltage from the fuel cell and to cancel ripple through mutual inductance;
a high frequency converter with a plurality of switching elements adapted to convert the direct current voltage from the boost converter into a square wave; and
an AC to AC converter adapted to reduce a current in each of the switching elements of the high frequency converter substantially to zero before a switching element is switched.
